(19) United States
(12) Patent Application Publication
(10) Pub. No.: US 2025/0121547 A1
(43) Pub. Date: Apr. 17, 2025

(54) INJECTION MOLDING CONTROLLER AND SYSTEM

(71) Applicant: PLASTECO CORPORATION, Osaka (JP)

(72) Inventors: Ryutarou HAYASHI, Osaka (JP); Shinji FUJIOKA, Osaka (JP); Shiho IWAKI, Osaka (JP)

(21) Appl. No.: 18/999,171

(22) Filed: Dec. 23, 2024

Related U.S. Application Data
(63) Continuation of application No. PCT/JP2023/040663, filed on Nov. 11, 2023.

(30) Foreign Application Priority Data
Nov. 11, 2022 (JP) 2022-181450

(51) Int. Cl. B29C 45/77; B29K 105/04

(52) U.S. Cl. CPC B29C 45/77; B29C 2945/76056; B29C 2945/76387; B29C 2945/76545; B29K 2105/04

(57) ABSTRACT

An injection molding controller and other techniques are used for injecting a resin that foams substantially uniformly in a mold. An injection molding controller (2) for feeding a material to be mixed into a resin to be injected includes a control unit (3) that obtains feed information (7a) including a feed speed of the material based on resin amount information (6a) including a resin amount of molten resin filling a space in front of a screw (17c) in an injection molding device (10) per predetermined time when the screw retracts to a predetermined weighing position (19).

### CROSS-REFERENCE TO RELATED APPLICATIONS

This application is a continuation application of International Patent Application No. PCT/JP2023/040663 filed on Nov. 11, 2023, which claims priority to Japanese Patent Application No. 2022-181450 filed on Nov. 11, 2022, the entire contents of which are incorporated by reference.

### BACKGROUND OF INVENTION

### Field of the Invention

The present invention relates to, for example, an injection molding controller, and more specifically, to, for example, an injection molding controller that feeds an inert gas to an injection molding device to cause a resin to foam.

### Background Art

Patent Literature 1 describes a blow molding material feeding system that introduces a blow molding material into a polymeric foam processing system. The blow molding material feeding system selectively feeds, for example, a blow molding material from a supply source to an extruder barrel or through a bypass.

Patent Literature 2 describes an injection molding apparatus that regulates the rate (solubility) of a supercritical fluid injected into and dissolved in a molten material independently of the set speed of screw rotation. The injection molding apparatus includes a flow rate resetter that determines the flow rate settings of a supercritical fluid by multiplying the set speed of screw rotation by a coefficient set by a coefficient setter that sets a coefficient for the type of a material or the type of a supercritical fluid, and then resets the determined flow rate in a flow rate setting unit.

### CITATION LIST

### Patent Literature

Patent Literature 1: Japanese Unexamined Patent Application Publication (Translation of PCT Application) No. 2003-525780

Patent Literature 2: Japanese Unexamined Patent Application Publication No. 2003-154526

A known injection molding system injects, into a mold, an injection material obtained by adding an additive to a molten resin. During weighing performed by the injection molding device, this system mixes an additive at a regular rate into a resin for filling a cylinder. However, the speed at which the resin fills the cylinder varies with a change of, for example, the rotation rate of a screw in the injection molding device or the retraction speed of the screw. The rate of the additive thus may partially vary in the resin for filling. When the injection material with the varying additive rate is injected into a mold, the additive in a molded product may be dispersed unevenly.

For a foam resin, when, for example, a gas is added at a partially varying rate to a resin to be injected, the injected resin may foam unevenly in the mold. Thus, the expansion ratio of the entire injected resin is reduced to avoid reducing the strength of a portion that foams most. This may obstruct weight reduction of a foamed product.

### SUMMARY OF INVENTION

One or more aspects of the present invention are directed to an injection molding controller, an injection molding apparatus, and an injection molding system for mixing a material into a resin to be injected at a rate appropriate for the resin, to a program for the controller, to a method for preparing an injection material, to a method for manufacturing a molded body obtained by mixing a material into a resin to be injected at a rate appropriate for the resin, and to the molded body.

(1) An injection molding controller according to an aspect of the present invention is a controller for feeding a material to be mixed into a resin for filling an injection molding device. The controller includes a control unit that obtains feed information about a feed speed of the material based on filling information about a filling rate of the resin during a weighing operation of the injection molding device.

The filling information refers to information including the filling rate of the resin for filling a cylinder in the injection molding device and information about the filling rate. The filling information is a concept including the quantity convertible to the filling rate, such as the amount of the resin used for filling per predetermined time or time taken for filling with a predetermined amount of resin. For example, the flow rate includes a mass flow rate and a volume flow rate.

When, for example, the filling rate of the resin is calculated as the filling information based on the retraction speed of a screw, the filling information includes the retraction speed of the screw and information about the retraction speed of the screw. The filling information is a concept including any quantity convertible to the retraction speed of the screw, such as a distance by which the screw moves after a predetermined time or time taken to move a predetermined distance.

When, for example, the weight change speed of a resin storage hopper to feed the resin to the injection molding device is to be used as the filling information, the filling information includes the weight change speed of the hopper and information about the weight change speed of the hopper. The filling information is a concept including any quantity convertible to the weight change speed of the hopper, such as a weight change after a predetermined time or time taken to reduce a predetermined weight.

A material to be mixed is any material such as a gaseous, liquid, or solid additive to be mixed into the resin.

The feed information includes the feed rate of a material to be mixed and information about the feed rate. The feed information is a concept including any quantity convertible to the feed rate, such as a change of the feed amount after a predetermined time or time taken to feed a predetermined amount.

(2) In the injection molding controller, the filling information may be obtained at each of one or more preregistered times. The feed information may be obtained for the filling information obtained at each of the one or more preregistered times.

(3) At an initial stage of retraction of a screw for weighing, a preregistered initial weighing duration or an initial retraction rate of the screw may be set. During the initial weighing duration or during an operation at the initial retraction rate, a preregistered initial feed rate to feed the material may be set.

(4) The filling information may be based on position information about a position of a screw in the injection molding device.

The position information refers to, for example, information about the screw position. The position information is a concept including the retraction rate of the screw, a measured value of the screw position, and any quantity convertible to these.

(5) The material may be an inert gas and a supercritical fluid.

(6) An injection molding apparatus according to an aspect of the present invention includes the controller described above and a mixture feeder that feeds the material based on the feed information from the controller.

(7) An injection molding system according to an aspect of the present invention includes the injection molding apparatus described above and an injection molding device to be fed with the material by the injection molding apparatus.

The injection molding device may include a mold. The mold may be attached to a mold open-close device. The mold open-close device may transmit a mold close signal.

(8) A program according to an aspect of the present invention is a program for a controller for feeding a material to be mixed into a resin for filling an injection molding device. The program causes a computer to perform operations including obtaining position information including a position of a screw that retracts for weighing in the injection molding device, obtaining filling information about a filling speed of the resin based on the position information, and calculating feed information including a feed speed of the material based on the filling information and a predetermined condition.

(9) A method according to an aspect of the present invention is a method for preparing, in a weighing operation of an injection molding device, an injection material by feeding a material to be mixed into a resin for filling. The method includes obtaining filling information about a filling rate of the resin at a preregistered time during the weighing operation, and feeding the material based on feed information about a feed rate corresponding to the filling information.

(10) A method for manufacturing a molded body according to an aspect of the present invention includes preparing an injection material with the method for preparing the injection material described above, and injecting the injection material into a mold.

(11) A molded body according to an aspect of the present invention is formed by injecting, into a mold, an injection material prepared by feeding a material to be mixed into a resin for filling in a weighing operation of an injection molding device. Filling information about a filling speed of the resin is obtained at predetermined intervals during the weighing operation. Feed information about a feed speed corresponding to the filling information at each of the predetermined intervals is obtained. An injection material fed with the material based on the feed information is prepared. The prepared injection material is injected to form the molded body.

### Advantageous Effects

The injection molding controller, the injection molding apparatus, the injection molding system, the program for the control controller, and the method for preparing an injection material according to the above aspects of the present invention can produce an injection material that is less likely to have an uneven rate of a material being mixed. The method for manufacturing a molded body and the molded body according to the above aspects of the present invention allows a material to be less likely to have an uneven rate of a material being mixed.

### BRIEF DESCRIPTION OF THE DRAWINGS

FIG. 1 is a graph of an example filling rate of a resin and an example feed rate of a material to be mixed in a weighing duration.

FIG. 2 is a functional block diagram of an example function of an injection system.

FIG. 3 is a schematic diagram of a control unit, showing its example hardware configuration.

FIG. 4 is a flowchart of a process performed by a control unit in an embodiment.

FIG. 5 is a schematic diagram of an example data structure of a table storing set values.

FIG. 6 is a flowchart of a process performed by the control unit in the embodiment.

FIG. 7 is a schematic diagram of a cylinder describing the state of filling the cylinder with a resin.

FIG. 8 is a graph describing the state of feeding a material to be mixed based on the amount of resin.

FIG. 9 is a schematic diagram of an operation procedure of a mixture feeder.

FIG. 10 is a flowchart of a method for preparing an injection material and a method for manufacturing a molded body.

FIG. 11 is a schematic diagram of the distribution of expansion ratios of a molded body and a known molded body.

### DETAILED DESCRIPTION

### 1. Brief Description

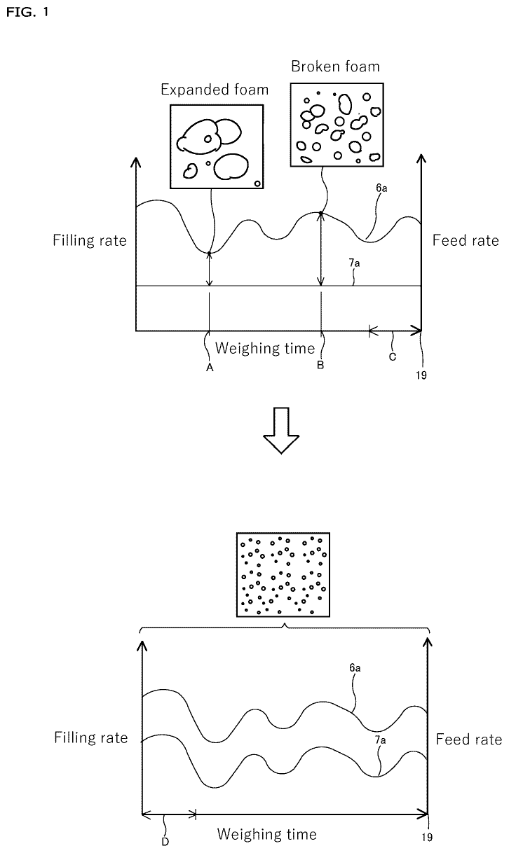

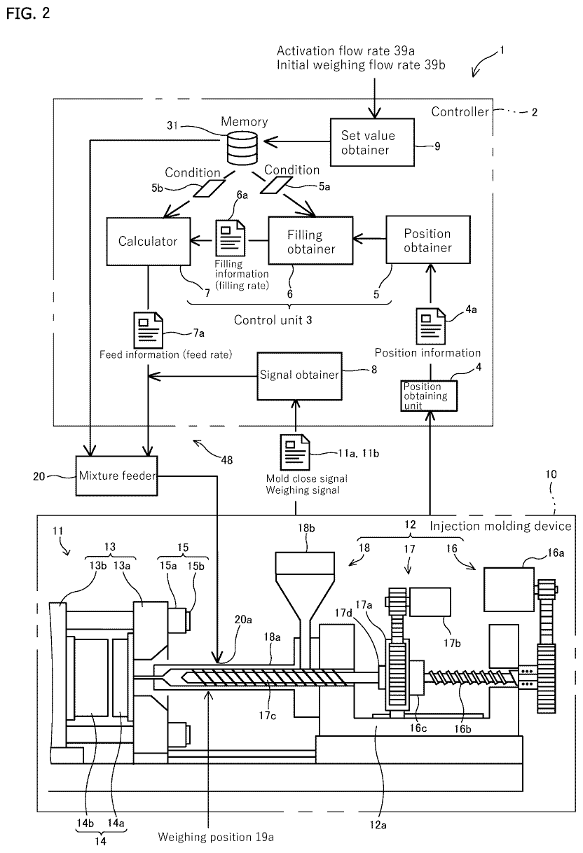

First, with reference to FIGS. 1 and 2, the operation of an injection system according to an embodiment of the present invention is schematically described in comparison with a known injection system.

FIG. 1 shows filling information (filling rate) 6a on a resin at which a cylinder 18a (refer to FIG. 2) is to be filled with the resin in an injection molding device 10 in a weighing duration (weighing duration 19), and feed information (feed rate) 7a on a material (gas) to be mixed into the resin. As illustrated, the resin filling rate 6a normally fluctuates possibly due to, for example, a change in the rate of the resin dropped from a hopper 18b and a change in the rotation speed of a screw 17c in the injection molding device.

An upper half of FIG. 1 is a schematic diagram of another injection system that regulates a gas feed rate 7a at, for example, a constant rate in the weighing duration 19.

For example, at a point corresponding to a lower filling rate 6a (refer to reference sign A in FIG. 1), an excess amount of gas is fed for the amount of the resin used for filling. The point A is thus likely to cause a molded product having expanded foams (refer to a schematic diagram of a molded body above the reference sign A). In contrast, at a point corresponding to a higher filling rate 6a (refer to reference sign B in FIG. 1), a smaller amount of gas is fed for the amount of the resin used for filling. The point B is thus likely to cause a molded product with broken foams (refer to a schematic diagram of a molded body above the reference sign B).

The fluctuation of the filling rate 6a may terminate filling of a planned amount of resin earlier. In contrast, the gas is fed at a constant gas feed rate 7a, and thus fails to be mixed at a planned rate into the amount of the resin used for filling. In response to this, the gas feed rate is increased to correspond to the amount of the resin used for filling to feed the entire gas. For example, the gas feed rate is increased to feed the entire planned amount of gas for 70 to 90% of the resin for filling.

At an initial stage of (time with reference sign D in the figure) of resin filling, the resin filling rate 6a tends to be unstable. For example, the resin filling rate 6a fluctuates at high amplitude, for example, rises or falls. The high amplitude obstructs mixture of the gas into the resin at a gas feed rate 7a corresponding to the filling rate 6a of resin.

A lower half of FIG. 1 is a schematic diagram of an injection system according to the embodiment of the present invention. As illustrated, the gas is fed at the feed rate 7a corresponding to the filling rate 6a. For example, the feed rate 7a rises at a point corresponding to a higher filling rate 6a, and the feed rate 7a falls at a point corresponding to a lower filling rate 6a. The gas is fed at a feed speed corresponding to the filling speed until the end of resin filling.

This injection system is thus likely to form a molded product having foams with a substantially uniform diameter (refer to the diagram above the graph). The injection system according to the embodiment of the present invention that feeds a gas (a material to be mixed) at a feed rate 7a corresponding to the filling rate 6a will be described below in detail.

### 2. Description of Components

### Injection System 1 and Injection Molding Apparatus 48

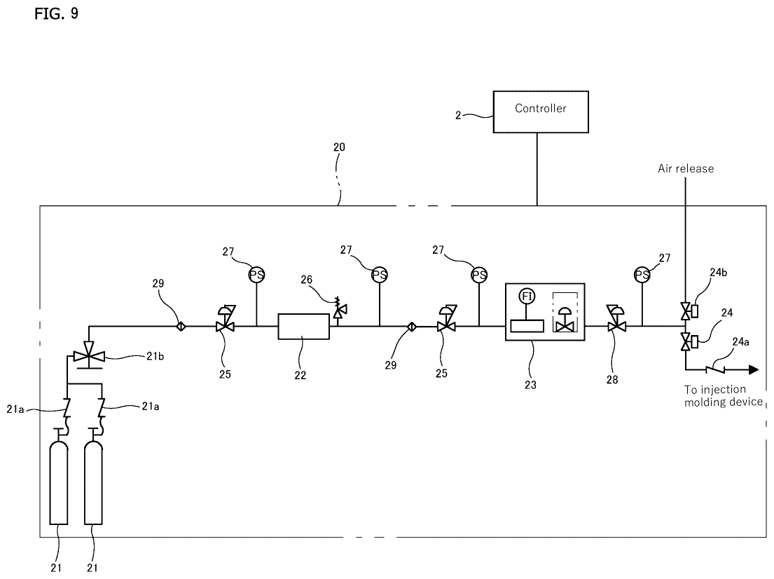

An injection system (hereafter referred to as a system) according to the embodiment of the present invention will be described with reference to a functional block diagram shown in FIG. 2. A system 1 shown in FIG. 2 includes an injection molding device 10, a mixture feeder 20 that feeds a material to be mixed into a resin melted in the injection molding device 10, and an injection molding controller 2. In the present embodiment, the mixture feeder 20 is a gas feeder. The gas feeder 20 includes a flow rate adjusting valve 23 (refer to FIG. 9) for adjusting the gas feed rate. In the figure, the injection molding device 10 is integral with a mold 14, but may be a separate component without the mold 14.

The controller 2 and the gas feeder (mixture feeder) 20 that feeds a material to be mixed based on the feed rate 7a from the controller 2 are included in an injection molding apparatus 48. The gas feeder 20 will be described later in detail.

### Controller 2

The controller 2 is an assembly for injection molding, and feeds a gas to be mixed into a resin to be injected. In the present embodiment, an inert nitrogen gas in a supercritical fluid state is used as a gas to be mixed.

In the present embodiment, for example, the controller 2 includes a control unit 3, a position obtaining unit 4, and a storage 31.

### Control Unit 3

The control unit 3 mainly includes, for example, a position obtainer 5, a filling obtainer 6, and a calculator 7. In the present embodiment, the control unit 3 further includes a signal obtainer 8 and a set value obtainer 9.

### Position Obtaining Unit 4

The position obtaining unit 4 is a rotary encoder in the present embodiment. The rotary encoder 4 detects the rotation rate of a motor that causes the screw 17c to advance or retract. In the present embodiment, the rotation rate of the motor is obtained as position information 4a.

The encoder is a known encoder. The encoder is, for example, a mechanical, optical, magnetic, or electromagnetic encoder. The encoder detects rotation with a sensor device as the amount of a physical change, and transmits rotation-angle information as an electric signal to an external device. Based on the signal obtained from the encoder, at least the information about the rotation rate of the motor is obtained. In addition, information about the rotation speed, the rotation direction, or the rotation position may be obtained.

In some embodiments, a known sensor that detects the position of the screw 17c with, for example, a change in a magnetic force or a change in an electric current may be used as another position obtaining unit 4.

The position obtainer such as the rotary encoder 4 may be incorporated in the injection molding device 10.

### Position Obtainer 5

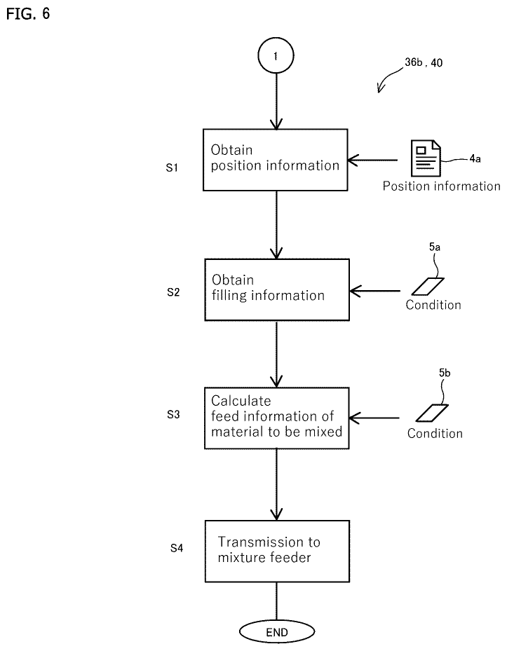

The position obtainer 5 obtains the position information 4a at predetermined intervals using the position obtaining unit 4. In the present embodiment, for example, the position obtainer 5 obtains the position information 4a at predetermined intervals of 0.1 to 0.5 s (sampling intervals). Step S1 (refer to FIG. 6) is performed using the position obtainer 5 in the embodiment.

### Timing to Obtain Position Information 4a

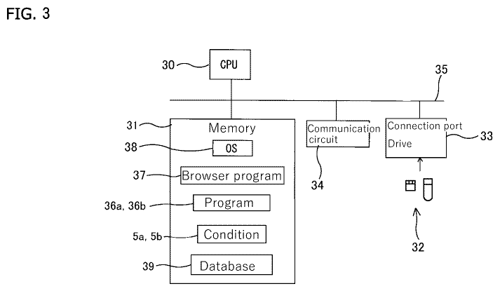

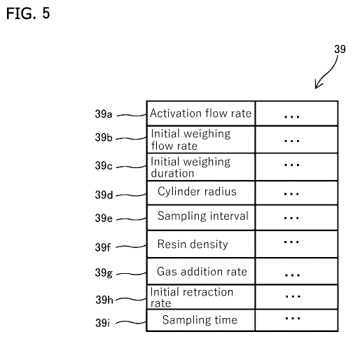

Timing to obtain the position information 4a is preregistered in the storage 31 (refer to FIG. 3). In the present embodiment, the position information 4a is obtained at sampling intervals 39e (refer to FIG. 5). For example, the sampling interval 39e may be set as appropriate.

In some embodiments, a sampling time 39i may be prestored in the storage 31, and the position information 4a may be obtained at any time during weighing. The sampling time 39i may include weighing start time of 0.

### Filling Obtainer 6

The filling obtainer 6 obtains the filling rate 6a based on the position information 4a including the current position of the screw 17c. In the present embodiment, in addition to the position information 4a, the filling rate 6a is obtained based on a condition 5a (described later) including set values such as the radius of the cylinder. Step S2 (refer to FIG. 6) is performed using the filling obtainer 6 in the embodiment.

### Calculator 7

The calculator 7 calculates and obtains the gas feed rate 7a based on the filling rate 6a and a predetermined condition 5b (described later). The obtained feed rate 7a is transmitted to the gas feeder 20. Step S3 (refer to FIG. 6) is performed using the calculator 7 in the embodiment.

### Signal Obtainer 8, Mold Close Signal 11a, and Weighing Signal 11b

The signal obtainer 8 obtains signals from the injection molding device 10. In the present embodiment, signals include, for example, a mold close signal 11a for the mold 14 and a weighing signal 11b indicating that the molten resin is currently being weighed.

### Mold Close Signal 11a

The mold close signal 11a indicates that the mold 14 is closed. For example, the mold close signal 11a indicates closing of the mold 14 that has been opened for molding a subsequent product. In the present embodiment, for example, the mold close signal 11a indicates the start of closing the mold 14. In some embodiments, the mold close signal 11a may indicate the end of closing the mold 14.

### Weighing Signal 11b

The weighing signal 11b indicates a weighing duration. In the present embodiment, for example, the weighing signal 11b indicates that the rotation direction of the rotary encoder 4 is the direction in which the screw 17c retracts. In some embodiments, the weighing signal 11b may indicate detection of the retraction of the screw 17c by, for example, a sensor external to the cylinder 18a.

### Set Value Obtainer 9

The set value obtainer 9 obtains various set values. The obtained set values are stored in the storage 31 (described later). In the present embodiment, the set value obtainer 9 obtains set values manually input by an operator through an input terminal including a touch sensor, a smartphone, and a personal computer.

In some embodiments, set values may be downloaded from, for example, a server through a network such as the Internet or an intranet.

### Resin 41

The material of the resin 41 is, for example, a thermoplastic resin. Examples of the thermoplastic resin include polylactic acid, polypropylene, polyamide, polyphenylene sulfide, polyimide, polyether-ketone, acrylonitrile butadiene styrene (ABS), acrylate styrene acrylonitrile (ASA), and polycarbonate.

### Material 42 to Be Mixed

In the present embodiment, a supercritical nitrogen gas is used as a material to be mixed. In some embodiments, a gas such as carbon dioxide or an inert gas may be used, or such a gas in a supercritical state may be used. The mixture feeder 20 may feed a gas, a liquid, or a solid. A solid may be powdery. For example, a physical property improver such as a cross-linker, a brancher, a plasticizer, a filler, or a nucleating additive may be used.

### 3. Hardware Structure

### Hardware Structure of Controller 2

With reference to FIG. 3, the hardware structure of the controller 2 will now be described.

A personal computer is used as an example of the controller 2 according to the present embodiment. As shown in FIG. 3, a personal computer includes a central processing unit (CPU) 30. The memory (storage) 31, a connection port 33 for connecting to and reading from, for example, a recording device 32, and a communication circuit 34 for communicating with an external device through a network are connected to the CPU 30 with a bus line 35. The memory 31 records the conditions 5a and 5b, a database 39, programs 36a and 36b for processing the system according to the embodiment of the present invention, a browser program 37, and an operating system (OS) 38.

In the present embodiment, the programs 36a and 36b operate in cooperation with the functions of the OS 38 and the browser program 37. The programs 36a and 36b may operate independently of the browser program 37 or the OS 38. The conditions 5a and 5b, the programs 36a and 36b, the browser program 37, and the OS 38 are, for example, downloaded into the memory 31 through the communication circuit 34 or installed into the memory 31 from the device 32 through the connection port 33.

In the above hardware structure, the functions shown in FIG. 2 are implemented using, for example, the CPU 30 and the programs 36a and 36b, but all or at least one of the functions may be sequentially controlled using a logical circuit such as a microcomputer, or a programmable logic controller (PLC).

### 4. Program

### Flowchart of Initial Operation of Injection System 1

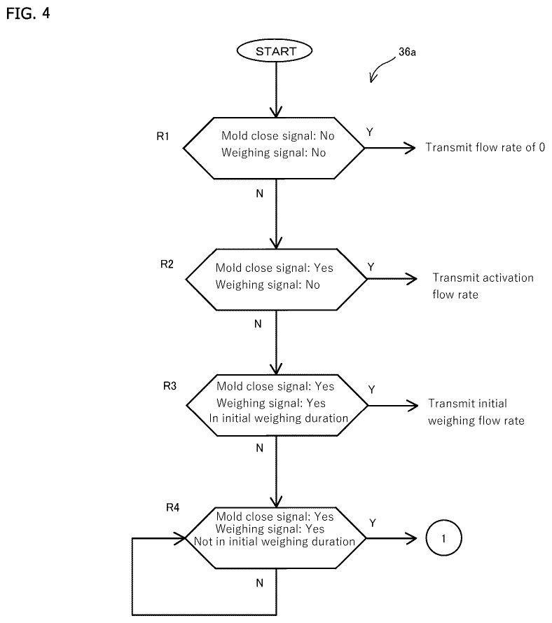

FIG. 4 is a flowchart of a procedure of a program executed by the controller 2 according to the embodiment. The flowchart in FIG. 4 mainly shows a procedure of the program 36a in injection molding preparation. For example, the flowchart shows a procedure of restarting the weighing after the injection operation is performed.

(R1): The CPU 30 in the controller 2 (refer to FIG. 3) transmits a value zero as a flow rate to the flow rate adjusting valve 23 (described later) in the gas feeder 20 (or closes the valve) when receiving neither the mold close signal 11a nor the weighing signal 11b.

In this state, a two-way valve 24 for the injection molding device and a two-way valve 24b for air release (refer to FIG. 9) are closed.

The CPU 30 may obtain a signal indicating that the mold 14 is open, and a signal indicating that the screw 17c is not retracting.

(R2): When receiving the mold close signal 11a and no weighing signal 11b, the CPU 30 transmits an activation flow rate 39a (refer to FIG. 5) to the gas feeder 20. The activation flow rate 39a is a flow rate at which the gas flows through the flow rate adjusting valve 23 before being fed to the molten resin. At the start of gas feeding, the flow rate adjusting valve 23 is likely to be less responsive. For example, a delay of about one second occurs before the flow rate is adjusted as appropriate in the present embodiment. In response to this, the CPU 30 obtains the signal 11a indicating the start of closing the mold 14, and allows the gas to flow to the flow rate adjusting valve 23 at a predetermined flow rate in advance. When the mold 14 starts closing and is then fastened under, for example, a hydraulic pressure in a closed state, weighing starts. At the start of weighing, the gas flow rate may be adjusted as appropriate. The response delay may be within or exceed one second.

In the present embodiment, the two-way valve 24b for air release (refer to FIG. 9) is opened to release, to the air, the gas flowing before being fed to the resin. The activation flow rate 39a is stored in, for example, the database 39 in the storage 31.

### Database 39

FIG. 5 is a schematic diagram of the database storing the set values. The database 39 shown in FIG. 5 stores predetermined set values. In the present embodiment, the set values in the database 39 include the activation flow rate 39a, an initial weighing flow rate 39b, an initial weighing duration 39c, a cylinder radius 39d, the sampling interval 39e, a resin density 39f, a gas addition rate 39g, an initial retraction rate 39h, and a sampling time 39i. These set values will be sequentially described with the associated components.

FIG. 4 is referred to again. (R3): When the CPU 30 obtains the mold close signal 11a and the weighing signal 11b in the initial weighing duration 39c, the CPU 30 transmits the initial weighing flow rate 39b (refer to FIG. 5) to the gas feeder 20.

The initial weighing duration 39c indicates a predetermined duration preset at an initial stage of weighing, or more specifically, at an initial stage of the retraction of the screw 17c (refer to reference sign D in FIG. 1). During the initial stage of the retraction of the screw 17c, the back pressure tends to be unstable. The unstable back pressure tends to cause the retraction rate of the screw 17c, or for example, the resin filling rate, to be unstable. Independently of the retraction rate of the screw 17c, the initial weighing flow rate 39b is set for the flow rate adjusting valve 23 in the initial weighing duration 39c. The initial weighing flow rate 39b is a mean gas feed rate calculated from the amount of resin per injection and the weighing duration 19.

For example, the initial weighing duration 39c may be less than 50%, or less than or equal to 30 to 20% of the entire weighing duration 19.

Instead of the initial weighing duration 39c, the initial retraction rate 39h (refer to FIG. 5) of the screw 17c may be set. For example, when the initial retraction rate 39h is set, the gas is fed at the initial weighing flow rate 39b while the screw 17c is operating at the initial retraction rate 39h.

For example, the initial retraction rate 39h may be less than 50%, or less than or equal to 30 to 20% of the entire retraction rate before reaching a weighing position 19a.

(R4): When the CPU 30 obtains the mold close signal 11a and the weighing signal 11b and the processing reaches or exceeds the initial weighing duration 39c, the CPU 30 transmits the gas feed rate to the gas feeder 20 based on the resin filling rate (the resin filling amount in the sampling interval 39e), and advances to the processing of feeding the gas (refer to FIG. 6).

### Flowchart of Weighing Operation by Injection System 1

FIG. 6 is a flowchart of a procedure of a program executed by the controller 2 according to the embodiment. The flowchart shown in FIG. 6 mainly shows the procedure of the program 36b for feeding the gas at a rate corresponding to the resin filling rate per sampling interval.

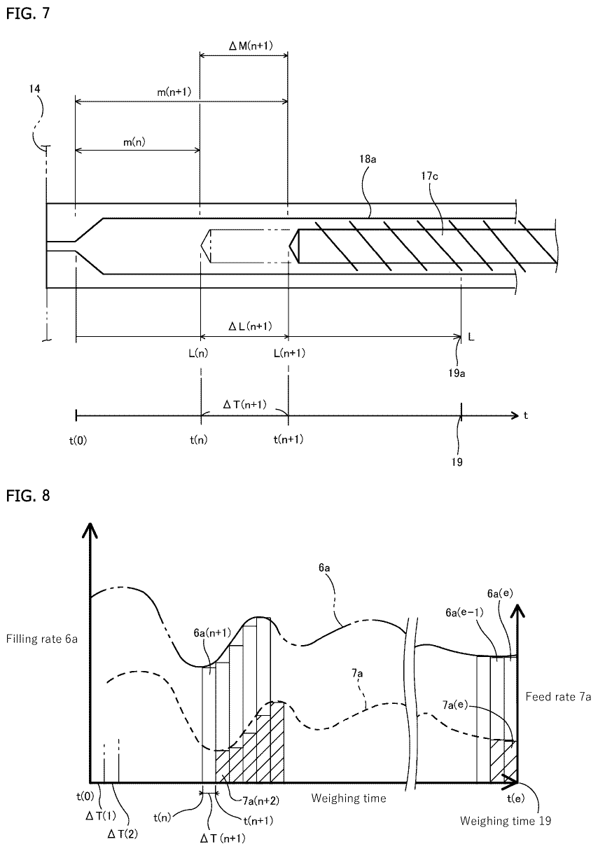

For ease of illustration, FIG. 7 will be additionally referred to below. FIG. 7 shows the screw 17c during the weighing operation. The mold 14 is located at the front end (on the left in the figure) of the cylinder 18a. The screw 17c retracts (moves rightward in the figure) inside the cylinder 18a. The resin is filled in a space between a wall in front of the cylinder 18a and the front end of the screw 17c. The horizontal axis in the figure indicates the distance by which the screw 17c retracts from the front end of the cylinder 18a. The distance L corresponds to the weighing position 19a. The horizontal axis below the distance L indicates the time elapsed after the screw 17c starts retracting. The time taken for the screw 17c to reach the weighing position 19a is the weighing duration 19. The retraction speed of the screw 17c fluctuates during weighing, and thus the length of the weighing duration 19 may vary by injection, but may be the same.

In the figure, the screw 17c is located at a distance L(n+1) at a time t(n+1). The two-dot-dash line indicates that the screw 17c is located at a distance L(n) at a time t(n) before the sampling interval.

An index n is a natural number starting from zero. For example, t(0) denotes the time when the screw 17c starts retracting. For example, the time t(n+1) denotes n+1-th sampling time. The time t(n) denotes n-th sampling time. ΔT(n+1) denotes a difference between the time t(n+1) and the time t(n).

The distance L(n+1) denotes the position of the screw 17c at the time t(n+1), and the distance L(n) denotes the position of the screw 17c at the time t(n). ΔL(n+1) denotes a difference between L(n+1) and L(n). ΔL(n) corresponds to the retraction amount of the screw 17c during a sampling interval ΔT(n).

(S1): The CPU 30 (refer to FIG. 3) in the controller 2 obtains the position information 4a of the retracting screw 17c. More specifically, the CPU 30 obtains the distance L(n) of the screw 17c at the time t(n) and the distance L(n+1) of the screw 17c at the time t(n+1)

(S2): The CPU 30 obtains the filling rate 6a. The filling rate 6a is calculated based on the condition 5a in addition to the position information 4a at the time t(n) and the time t(n+1). The condition 5a includes a formula into which a set value selected from the database 39 (refer to FIG. 5) and the position information 4a are substituted.

### Calculation of Filling Rate 6a

In the present embodiment, for example, the CPU 30 obtains the cylinder radius 39d, the sampling interval 39e, and the resin density 39f from the database 39 (refer to FIG. 5). The CPU 30 calculates the capacity of the cylinder 18a when the screw 17c retracts by the retraction amount L(n) based on the preregistered formula. The obtained capacity of the cylinder 18a is multiplied by the resin density 39f to calculate the resin amount m(n) fed to the cylinder 18a at the retraction amount L(n).

The CPU 30 obtains the resin amount m(n+1) at the time t(n+1) in the same manner as described above.

The CPU 30 further calculates the resin amount ΔM(n+1) by subtracting the resin amount m(n) from the resin amount m(n+1). The resin amount ΔM(n+1) corresponds to the resin filling amount during the time t(n) to the time t(n+1).

The CPU 30 then divides the resin amount ΔM(n+1) by a sampling interval 39e (ΔT(n+1)). The CPU 30 thus obtains the filling rate 6a(n+1) during the time t(n) to the time t(n+1) as the filling rate 6a (refer to FIG. 8).

FIG. 8 shows the filling rate 6a and the feed rate 7a per sampling interval ΔT. The horizontal axis indicates the time t. The left vertical axis indicates the filling rate 6a, and the right vertical axis indicates the feed rate 7a. The two-dot-dash line schematically shows the fluctuation of the filling rate 6a, and the dotted line schematically shows the fluctuation of the feed rate 7a. As illustrated, the filling rate 6a is calculated for each sampling interval ΔT. The filling rate 6a(n+1) indicates the filling rate during the sampling interval ΔT(n+1). The gas feed rate 7a(n+2) indicates the feed rate during the sampling interval ΔT(n+2).

(S3): The CPU 30 calculates the gas feed rate 7a(n+1). The gas feed rate 7a(n+2) is calculated based on the filling rate 6a(n+1) and the predetermined condition 5b. The condition 5b includes a formula into which a set value selected from the database 39 (refer to FIG. 5) and the filling rate 6a(n+1) are substituted. In the present embodiment, for example, the CPU 30 obtains the gas addition rate 39g from the database 39 as a set value. The CPU 30 calculates the gas feed rate 7a(n+2) during the subsequent sampling interval ΔT(n+2) by multiplying the filling rate 6a(n+1) of the resin by the gas addition rate 39g (refer to FIG. 6).

(S4): The obtained gas feed rate 7a(n+2) is transmitted to the gas feeder 20. The gas feeder 20 feeds the gas at the obtained gas feed rate 7a (n+2) during the interval ΔT(n+2).

When the screw 17c retracts to the weighing position 19a, the screw 17c stops retracting and rotating. The gas feeder 20 stops feeding the gas. In the present embodiment, for example, to stop the gas feeding, the two-way valve 24 (refer to FIG. 9) is closed, and the two-way valve 24b for air release is opened.

### Last Sampling Interval ΔT(e)

The last sampling interval reaching the weighing duration 19 is denoted with ΔT(e). The index e denotes the last. The sampling interval ΔT(e) may be shorter than the previous sampling interval ΔT(e−1). In the present embodiment, the gas is mixed at the feed rate 7a based on the resin filling rate 6a for each sampling interval ΔT, and thus, the gas may be fed at a rate corresponding to the filling rate 6a until the screw 17c reaches the weighing position 19a.

### First Sampling Interval ΔT(1)

When the back pressure tends to be stable at the initial stage of the retraction of the screw 17c, the mean gas feed rate (initial weighing flow rate 39b) may be provided as a feed rate 7a(1) in a first sampling interval ΔT(1). A feed rate 7a(2) may then be calculated based on the filling rate 6a(1) at a sampling interval ΔT(2), and the gas may then be fed.

### Other Details in Sampling Interval 39e and Sampling Time 39i

The sampling interval 39e may be irregular. For example, the sampling interval 39e may be extended for a duration in which the screw 17c has a stable back pressure, or may be shortened for a duration in which the screw 17c has an unstable back pressure. Instead of extending or shortening the sampling interval 39e, the sampling time 39i may be set individually to extend or shorten the sampling interval 39e.

### Other Details in Calculation of Filling Rate 6a

The position information 4a used to calculate the filling rate 6a can be obtained from any two or more sampling times 39i. These sampling times 39i may not be adjacent to each other. In this case, data such as the position information 4a at all the sampling times 39i obtained during the sampling intervals 39e may not be used. In some embodiments, the sampling times 39i used for calculation may be preregistered in the storage 31.

### Other Details in Calculation of Feed Rate 7a

The filling rate 6a used to calculate the feed rate 7a can be obtained from any two or more filling rates 6a. These filling rates 6a may not be adjacent to each other.

### 5. Injection Molding Device

### Injection Molding Device 10

Referring back to FIG. 2, an example of an injection molding device 10 included in the injection system 1 according to the embodiment of the present invention will be described. The injection molding device 10 includes a mold open-close device 11 and an injector 12 facing each other in the longitudinal direction of a main frame 10a. The injection molding device 10 according to the present embodiment has an electric motor assembly.

### Mold Open-Close Device 11

The mold open-close device 11 mainly includes a holder 13, the mold 14 in the holder 13, and open-close units 15 that close the holder 13. The holder 13 includes a stationary holder 13a and a movable holder 13b. The movable holder 13b is movable by the open-close units 15. Each open-close unit 15 includes an open-close servomotor 15a fixed to the stationary holder 13a, a ball screw 15b rotatable by the open-close servomotor 15a, and a ball screw nut (not shown) fixed to the movable holder 13b. In the present embodiment, the open-close units 15 are two or upper and lower open-close units 15. In some embodiments, the open-close units 15 may be one or three or more open-close units 15. When the open-close units 15 are three or more open-close units 15, they may be located at regular intervals.

When the open-close servomotor 15a is driven, the ball screw 15b rotates, and the movable holder 13b moves toward or away from the stationary holder 13a (in the front-rear direction). In the present embodiment, after the movable holder 13b moves and the mold 14 is closed, the mold 14 is fastened with, for example, a hydraulic device (not shown).

In the present embodiment, for example, a signal indicating detection of rotation of each open-close servomotor 15a in the direction to close the mold 14 is defined as the mold close signal 11a.

### Injector 12

The injector 12 includes a base 12a, a screw mover 16 fixed to the base 12a, a screw unit 17 movable by the screw mover 16, and a material feeder 18 to feed the resin to the screw unit 17.

### Screw Mover 16

The screw mover 16 moves the screw 17c in the screw unit 17 toward and away from the mold 14 (in the front-rear direction). The screw mover 16 includes, for example, an injection servomotor 16a located at the base 12a, a ball screw 16b driven by the injection servomotor 16a to rotate, and a ball screw nut 16c to be screwed on the ball screw 16b.

### Screw Unit 17

The screw unit 17 includes a movable portion 17a movable in the front-rear direction while being guided by the base 12a, a weighing servomotor 17b located at the movable portion 17a, and the screw 17c rotatable by the weighing servomotor 17b.

The ball screw 16b is fixed to the movable portion 17a. Thus, the movable portion 17a is movable in the front-rear direction with the rotation of the injection servomotor 16a. A pressure sensor 17d, such as a load cell that detects a resin pressure acting on the screw 17c, is located at the movable portion 17a.

### Material Feeder 18

The material feeder 18 includes the cylinder 18a located at the base 12a, and the hopper 18b that feeds a resin into the cylinder 18a. The screw 17c extends through the cylinder 18a. The screw 17c is rotatable and movable in the front-rear direction in the cylinder 18a. A heater (not shown) is located around the periphery of the screw 17c.

### Weighing Operation of Injection Molding Device 10

The weighing servomotor 17b is driven to rotate. The resin falls under gravity from the hopper 18b into the cylinder 18a with the rotation of the screw 17c. The resin fed from the hopper 18b and filled in the cylinder 18a is transferred to the far end of the screw 17c with the rotation of the screw 17c. While being transferred, the resin melts with the heat from the heater and the frictional heat or shearing heat from the rotation of the screw 17c. The molten resin is stored at the distal end of the cylinder 18a. The retraction speed of the movable portion 17a is controlled by the injection servomotor 16a to allow the screw 17c to receive a predetermined resin pressure (back pressure).

### Injection Operation of Injection Molding Device 10

The stored molten resin is injected with the advancing screw 17c. The advance speed of the movable portion 17a is controlled by the injection servomotor 16a to generate a predetermined resin pressure (an injection pressure and a dwell pressure).

### Cylinder 18a and Screw 17c in Embodiment

The cylinder 18a in the present embodiment has a diameter of 110 mm. The screw 17c has a full length of 550 mm. The length of the screw 17c used for molding is 60.2 to 61.3 mm with respect to the full length.

### 6. Gas Feeder

### Gas Feeder 20

FIG. 9 is a schematic diagram of an operation procedure of the gas feeder. The illustrated gas feeder 20 mainly includes tanks 21 each serving as a supply source of nitrogen gas, a booster pump 22 that applies a pressure on the nitrogen gas fed from the tanks 21, the flow rate adjusting valve 23 that adjusts the flow rate of the nitrogen gas obtained from the booster pump 22, and the two-way valve 24 connected to the injection molding device 10.

A three-way valve 21b is connected to the tanks 21 through check valves 21a. Each tank 21 is connected to a flow path toward the booster pump 22 through the three-way valve 21b.

A reducing valve 25 is located adjacent to the primary end of the booster pump 22, and a relief valve 26 is located adjacent to the secondary end of the booster pump 22. Pressure sensors 27 are located adjacent to the primary end of the booster pump 22 and adjacent to the secondary end of the booster pump 22 downstream from the relief valve 26.

Another reducing valve 25 is located adjacent to the primary end of the flow rate adjusting valve 23, and a back pressure adjusting valve 28 is located adjacent to the secondary end of the flow rate adjusting valve 23. Other pressure sensors 27 are located adjacent to the primary end of the flow rate adjusting valve 23 and adjacent to the secondary end of the flow rate adjusting valve 23 downstream from the back pressure adjusting valve 28.

A check valve 24a is located adjacent to the secondary end of the two-way valve 24 connected to the injection molding device 10. The two-way valve 24b to release the gas to air is located adjacent to the primary end of the two-way valve 24. Filters 29 are located upstream from the reducing valves 25.

The components including the booster pump 22, the flow rate adjusting valve 23, the two-way valve 24, the reducing valves 25, the pressure sensors 27, and the back pressure adjusting valve 28 are electrically connected to the controller 2. The controller 2 can obtain detection values from the components and information about open-close of the valves. The controller 2 can also instruct, for example, the open-close or the degree of opening of the valve of each component.

### Mixture Feeder 20 in Other Embodiments

When a material 42 to be mixed is liquid or solid, a feed port (not shown) connecting with the cylinder 18a is formed, and the liquid or solid material is fed through the feed port.

When, for example, the material is liquid, the liquid material 42 is fed through the flow path for the liquid connecting with the feed port using, for example, a pump that can adjust the liquid flow rate.

When, for example, the material is solid, a hopper assembly (refer to the hopper 18b described above) is located at the feed port. A controller to control the feed speed of the material 42, such as a screw feeder, is located at the hopper assembly.

### 7. Method for Preparing Injection Material

### Preparation Method 40

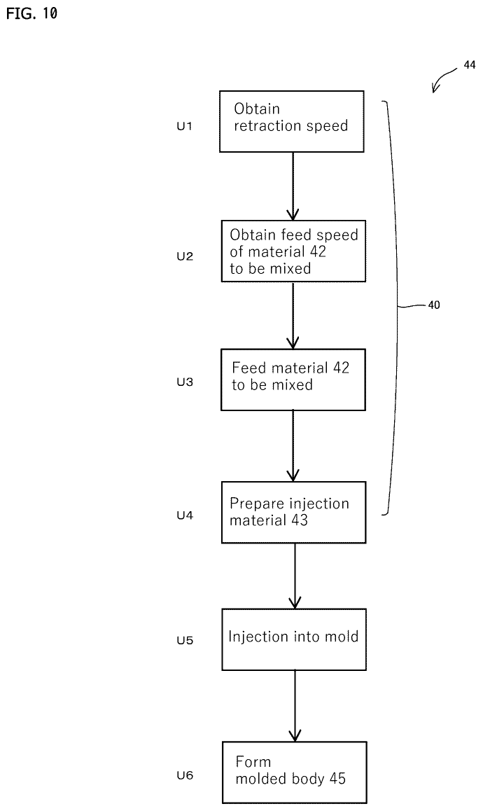

A preparation method according to an embodiment of the present invention (refer to FIG. 10) is used to prepare the injection material for filling the cylinder 18a in the injection molding device 10. An injection material 43 is prepared by feeding the material 42 to be mixed into the resin 41 for filling.

The illustrated preparation method 40 includes (U1) obtaining, at a preregistered time, the screw retraction speed (filling rate) 6a of the screw 17c in the injection molding device that retracts to the predetermined weighing position 19a, (U2) obtaining the feed information (feed rate) 7a corresponding to the filling rate, and (U3) feeding the material 42 to be mixed into the resin 41 to be injected. The injection material 43 is thus prepared (U4).

### Injection Material 43

For the injection material 43 prepared with the preparation method 40, the filling information (filling rate) 6a is obtained (monitored) while the resin 41 is being filled, and the material 42 is mixed into the resin 41 at the feed information (feed rate) 7a corresponding to the filling rate 6a. Thus, the material 42 is added at a substantially uniform rate. In particular, the material 42 is added at a substantially uniform rate in the axial direction of the injection material 43 along the screw 17c.

### 8. Manufacturing Method

### Manufacturing Method 44

A method for manufacturing a molded body according to an embodiment of the present invention (refer to FIG. 10) includes (U5) injecting the injection material 43 prepared with the preparation method 40 into the mold 14. After the injection, for example, the material 43 is cooled and released, and thus a molded body 45 can be obtained (U6). The molded body 45 is formed by injecting the injection material 43 obtained by mixing the material 42 into the resin 41 at a predetermined rate, and thus the material 42 tends to be uniformly dispersed in the mold 14. Thus, the molded body 45 including the substantially uniformly dispersed material 42 can be manufactured.

### 9. Molded Body

### Molded Body 45

A molded body according to an embodiment of the present invention is formed by injecting, into the mold 14, the injection material prepared by feeding the material 42 to be mixed into the resin 41 for filling, in the weighing operation of the injection molding device 10 (refer to FIG. 2).

In preparation of the injection material 43, the filling rate 6a associated with the filling speed of the resin 41 is obtained during a predetermined interval (sampling interval 39e) during the weighing operation. In addition, the feed rate 7a associated with the feed speed of each filling rate 6a is obtained. In addition, the injection material 43 fed with the material 42 based on the feed rate 7a is prepared. The injection material 43 including the material 42 prepared at substantially the predetermined rate is injected into the mold 14, and formed into the molded body 45.

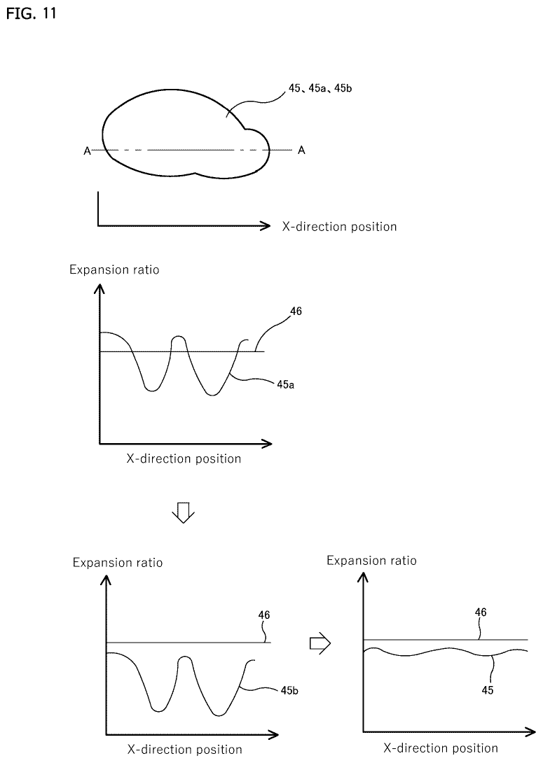

For example, the molded body 45 including the material 42 that is an inert gas and a supercritical fluid will be described. FIG. 11 is a graph schematically showing the distribution of the expansion ratios of the molded body 45 according to the embodiment of the present invention and known molded bodies 45a and 45b. The molded body 45, a defective molded body 45a, and the known molded body 45b shown at the top of FIG. 11 are, for example, foamed plate-like members. The x-axis indicates the position of the molded body in the x-direction. The molded bodies 45, 45a, and 45b have the same shape. The molded bodies 45 and 45a have the same expansion ratio. The molded body 45b has a lower expansion ratio than the molded bodies 45 and 45a.

### Defective Molded Body 45a

The graph immediately below the molded bodies 45, 45a, and 45b schematically shows the average expansion ratio of the defective molded body 45a in the cross section at the x position. A straight line 46 indicates the expansion ratio intended in the design of the molded bodies 45 and 45a. When each molded body has an expansion ratio exceeding the straight line 46, the expansion ratio is high, and the strength is lowered. Normally, a molded product is designed to have an expansion ratio not exceeding the straight line 46. Thus, the defective molded body 45a is inappropriate for a product.

### Known Molded Body 45b

The defective molded body 45a has an expansion ratio with a larger fluctuation, and the highest portion of the expansion ratio exceeds the straight line 46. Thus, the strength of that portion falls below the designed strength. In such a case, as shown with a downward arrow in the graph, the entire expansion ratio is lowered to have the highest expansion ratio below the straight line 46. Thus, the weight of the molded body 45b is likely to increase.

### Molded Body 45 According to Embodiment of Present Invention

The molded body 45 according to the embodiment of the present invention has an expansion ratio with a smaller fluctuation, and a line 45 indicating the expansion ratio approximates the straight line 46. Thus, the molded body 45 has entirely uniform strength. The molded body 45 has a lighter weight than the known molded body 45b. The molded body 45 formed from the injection material 43 obtained by mixing the gas 42 into the resin 41 at a substantially uniform ratio has a substantially uniform expansion ratio, and thus has a lighter weight.

### Molded Body According to Example

A molded body of a car component according to an example will now be described. Parameters for manufacturing a side panel of a car will be described below.
Molded body: side panel
Dimensions: about 1500 in width×300 mm in height
Weight: 351.6 g
Volume: 493.9 cm³; the volume of the molded body 47 (side panel)
Resin Density: 710 mg/cm³
Cylinder Diameter: 110 mm
Gas Set Value: 0.3%; the weight of the gas to be injected, or 0.3% of the resin amount of the molded body 47
Injection Start Position: 1 mm; the gas 42 is injected after the screw 17c retracts by 1 mm in response to the unstable back pressure at the initial stage of the retraction of the screw 17c
Measurement Calibration: 60.2 mm; the length of the screw 17c used for molding with respect to the full length.
Initial Weighing Flow Rate: 200 mg/sec
Initial Weighing Duration: 3.0 sec
Weighing Duration: about 7.0 sec
Sampling Interval: 0.3 sec

### 10. Others

The injection molding device 10 according to the present embodiment includes the injection servomotor 16a and the weighing servomotor 17b, but either one or both of the servomotors may be replaced by, for example, hydraulic or pneumatic units using a fluid.

Each open-close unit 15 in the mold open-close device 11 may be, for example, a hydraulic or pneumatic unit using a fluid.

In the present embodiment, a horizontal injection molding device is described as an example, but the technique is also applicable to a vertical injection molding device.

The mold close signal 11a may be transmitted when the mold 14 is closed or fastened hydraulically to be ready for injection.

In step R1, to reset the gas flow rate to zero, the two-way valve 24 (refer to FIG. 9) and the two-way valve 24b for air release may be closed or may be open.

The air release path may be connected to the primary end of the booster pump 22 to return the gas.

The activation flow rate 39a may be the same as the initial weighing flow rate 39b.

The molded body 45 may be a component of a daily use product, a ship, an aircraft, or a spacecraft, in addition to a car.

### Other Details of Filling Rate

The feed rate 7a of a material to be mixed is obtained based on the retraction speed of the screw 17c. The feed rate 7a may be obtained based on a change in the weight of the hopper 18b.

In some embodiments, the feed rate of the material may be calculated with a formula including the retraction speed of the screw 17c as a function. In this case, the resin filling rate may not be used (calculated).

### Other Details of Calculation of Feed Rate 7a

The feed rate 7a(n+2) during the sampling interval ΔT(n+2) may be calculated based on the filling rate 6a during multiple intervals such as the sampling intervals ΔT(n) and ΔT(n+1).

Instead of calculation of the filling rate 6a, a table including the filling rate 6a and the corresponding feed rate 7a may be prestored in the storage 31 (refer to FIG. 3), and the obtained feed rate 7a corresponding to the filling rate 6a may be obtained from the table.

### 11. Overview

(1) The injection molding controller 2 according to an embodiment of the present invention is a controller for feeding a material to be mixed into a resin for filling the injection molding device 10. The injection molding controller 2 includes the control unit 3 that obtains feed information 7a about the feed speed of the material based on the filling information 6a about the filling speed of the resin during the weighing operation of the injection molding device.

In the weighing duration 19, the filling rate 6a may be monitored to use the feed rate 7a corresponding to the filling rate 6a.

(2) The above injection molding controller 2 obtains the filling information 6a at each of one or more preregistered times, and the feed information 7a is obtained for the filling information 6a obtained at each time. Thus, the injection molding controller 2 can change or modify the feed rate of the material 42 to a further appropriate rate during the weighing operation with more pieces of the filling information 6a being sampled.

(3) At the initial stage of retraction of the screw 17c for weighing, the preregistered initial weighing duration 39c or the initial retraction rate 39h of the screw is set, and the preregistered initial weighing flow rate 39b to feed the material 42 is set during the initial weighing duration 39c or during the operation at the initial retraction rate 39h. Thus, the material 42 can be fed as appropriate at the initial stage of filling.

(4) The filling information 6a is based on the position information 4a about the position of the screw 17c in the injection molding device 10, and thus can be easily identified. The feed rate 7a is thus easily controllable.

(5) The material 42 is an inert gas and a supercritical fluid. The gas 42 can be substantially uniformly added to the injection material 43. Thus, the injection material 43 tends to substantially uniformly foam in the mold 14.

(6) The injection molding apparatus 48 according to an embodiment of the present invention includes the controller 2 described above and the mixture feeder 20 that feeds the material 42 based on the feed information 7a from the controller.

The material 42 can be fed at the feed rate 7a corresponding to the filling rate 6a of the resin 41 for filling the injection molding device 10.

(7) The injection molding system 1 according to an embodiment of the present invention includes the injection molding apparatus 48 described above and the injection molding device 10 to be fed with the material 42 by the injection molding apparatus 48.

The variation of the rate of the material 42 to the resin 41 in the injection material 43 can be avoided. The material 42 can be mixed into the resin 41 of the injection material 43 at a substantially uniform rate.

(8) The program 36 according to an embodiment of the present invention is a program for a controller for feeding a material to be mixed into a resin for filling the injection molding device 10. The program 36 causes a computer to perform operations including obtaining the position information 4a including the position of the screw 17c that retracts for weighing in the injection molding device, obtaining the filling information 6a about the filling rate of the resin based on the position information 4a, and calculating the feed information 7a including the feed rate of the material based on the filling information and the predetermined condition 5b.

In the weighing duration 19, the filling rate 6a can be monitored, and the feed rate 7a can be changed or corrected to correspond to the filling rate 6a.

(9) The preparation method 40 according to an embodiment of the present invention is a method for preparing, in a weighing operation of the injection molding device 10, the injection material 43 by feeding the material 42 to be mixed into the resin 41 for filling. The preparation method 40 includes obtaining the filling information 6a about the filling rate of the resin 41 at a preregistered time during the weighing operation, and feeding the material 42 based on the feed information 7a about the feed rate corresponding to the filling information 6a.

The feed rate of the material 42 can be changed or corrected based on the amount of resin used for filling at the preregistered time during the weighing operation. In the injection material 43, the variation of the rate of the material 42 to the resin 41 can be avoided. In particular, the addition rate of the material 42 is unlikely to vary in the axial direction of the injection material 43. The material 42 can be mixed into the resin 41 of the injection material 43 at a substantially uniform rate.

(10) The manufacturing method 44 for manufacturing a molded body according to an embodiment of the present invention includes preparing the injection material 43 with the preparation method 40 for preparing the injection material 43 described above, and injecting the injection material 43 into the mold 14.

The injection material 43 including the material 42 substantially uniformly added to the resin 41 is injected into the mold 14, and thus the material 42 is substantially uniformly dispersed in the mold 14.

(11) The molded body 45 according to an embodiment of the present invention is formed by injecting, into the mold 14, the injection material 43 prepared by feeding the material 42 to be mixed into the resin 41 for filling in the weighing operation of the injection molding device 10. The filling information 6a about the filling speed of the resin 41 is obtained at the predetermined intervals 39e during the weighing operation. The feed information 7a about the feed speed corresponding to the filling information 6a at each of the predetermined intervals 39e is obtained. The injection material 43 fed with the material 42 based on the feed information 7a is prepared. The prepared injection material 43 is injected to form the molded body.

The injection material 43 including the resin 41 and the material 42 added to the resin 41 at a substantially uniform rate is injected into the mold 14, and thus the material 42 is substantially uniformly dispersed in the mold 14. Thus, the molded body 45 including the material 42 substantially uniformly dispersed is obtained. When the material 42 is an inert gas and a supercritical fluid, the molded body 45 can substantially uniformly foam and have lighter weight. When the material 42 is another additive, the molded body 45 can have uniform components, and thus can have substantially uniform mechanical characteristics including the strength.

### REFERENCE SIGNS LIST

1 injection system
2 controller
3 control unit
4 position obtaining unit
4a position information
5 position obtainer
5a condition
5b condition
6 filling obtainer
6a filling information (filling rate)
7 calculator
7a feed information (feed rate)
8 signal obtainer
9 set value obtainer
10 injection molding device
11 mold open-close device
11a mold close signal
11b weighing signal
12 injector
12a base
13 holder
13a stationary holder
13b movable holder
14 mold
15 open-close unit
15a open-close servomotor
15b ball screw
16 screw mover
16a injection servomotor
16b ball screw
16c ball screw nut
17 screw unit
17a movable portion
17b weighing servomotor
17c screw
17d pressure sensor
18 material feeder
18a cylinder
18b hopper
19 weighing duration
19a weighing position
20 mixture feeder (gas feeder)
21 tank
21a check valve
21b three-way valve
22 booster pump
23 flow rate adjusting valve
24 two-way valve (adjacent to injection molding device)
24a check valve
24b two-way valve (for air release)
25 reducing valve
26 relief valve
27 pressure sensor
28 back pressure adjusting valve
29 filter
30 CPU
31 memory
32 recording device
33 connection port
34 communication circuit
35 bus line
36a program
36b program
37 browser program
38 OS
39 database
39a activation flow rate
39b initial weighing flow rate
39c initial weighing duration
39d cylinder radius
39e sampling interval
39f resin density
39g gas addition rate
39h initial retraction rate
39i sampling time
40 preparation method
41 resin
42 material to be mixed
43 injection material
44 manufacturing method
45 molded body
46 expansion ratio in design
47 molded body
48 injection molding apparatus

1. An injection molding controller for feeding a material to be mixed into a resin for filling an injection molding device, the controller comprising:
a control unit configured to obtain feed information about a feed rate of the material based on filling information about a filling rate of the resin during a weighing operation of the injection molding device.

2. The injection molding controller according to claim 1, wherein
the filling information is obtained at each of one or more preregistered times, and the feed information is obtained for the filling information obtained at each of the one or more preregistered times.

3. The injection molding controller according to claim 1, wherein
at an initial stage of retraction of a screw for weighing, a preregistered initial weighing duration or an initial retraction rate of the screw is set, and
in the initial weighing duration or during an operation at the initial retraction rate, a preregistered initial feed rate to feed the material is set.

4. The injection molding controller according to claim 1, wherein
the filling information is based on position information about a position of a screw in the injection molding device.

5. The injection molding controller according to claim 1, wherein
the material is an inert gas and a supercritical fluid.

6. An injection molding apparatus, comprising:
the controller according to claim 1; and
a mixture feeder configured to feed the material based on the feed information from the controller.

7. An injection molding system, comprising:
the injection molding apparatus according to claim 6; and
an injection molding device to be fed with the material by the injection molding apparatus.

8. The injection molding system according to claim 7, wherein
the injection molding device includes a mold.

9. The injection molding system according to claim 8, wherein
the mold is attached to a mold open-close device, and
the mold open-close device transmits a mold close signal.

10. A non-transitory computer-readable storage medium storing a program for a controller for feeding a material to be mixed into a resin for filling an injection molding device, the program causing a computer to perform operations comprising:
obtaining position information including a position of a screw configured to retract for weighing in the injection molding device;
obtaining filling information about a filling rate of the resin based on the position information; and
calculating feed information including a feed rate of the material based on the filling information and a predetermined condition.

11. A method for preparing, in a weighing operation of an injection molding device, an injection material by feeding a material to be mixed into a resin for filling, the method comprising:
obtaining filling information about a filling rate of the resin at a preregistered time during the weighing operation; and
feeding the material based on feed information about a feed rate corresponding to the filling information.

12. A method for manufacturing a molded body, the method comprising:
preparing an injection material with the method for preparing the injection material according to claim 11; and
injecting the injection material into a mold.

13. A molded body formed by injecting, into a mold, an injection material prepared by feeding a material to be mixed into a resin for filling in a weighing operation of an injection molding device,
wherein filling information about a filling speed of the resin is obtained at predetermined intervals during the weighing operation,
feed information about a feed speed corresponding to the filling information at each of the predetermined intervals is obtained,
an injection material fed with the material based on the feed information is prepared, and
the prepared injection material is injected to form the molded body.
